(19) United States
(12) Patent Application Publication
(10) Pub. No.: US 2004/0100663 A1
(43) Pub. Date: May 27, 2004

(54) Hand-held scanning and marking apparatus

(76) Inventors: Spencer N. Pisczak, Chagrin Falls, OH (US); Joseph A. Vero, Aurora, OH (US)

Correspondence Address: TODD R. TUCKER, ESQ., RENNER, OTTO, BOISSELLE & SKLAR, LLP, 1621 Euclid Avenue, Nineteenth Floor, Cleveland, OH, 44115-2191, US

(21) Appl. No.: 10/238,082

(22) Filed: Nov. 26, 2002

(51) Int. Cl. H04N 1/028; H04N 1/107; G06K 9/22; B43K 29/00

(52) U.S. Cl. 358/473; 382/314; 401/52; 401/195

(57) ABSTRACT

An apparatus for scanning printed or graphical information is providing having an optical reader and an integral marking device such as an ink containing highlighter. The apparatus also has at least one output transmission device as well as an internal light source, a pressure sensitive switch for activating the light source and an ink shield/light tube for protecting the reader from the highlighter's ink. The apparatus can be of a single, integral construction.

### FIELD OF INVENTION

This invention generally relates to scanners and marking devices, and more particularly to hand-held scanners having integral marking capabilities.

### BACKGROUND OF INVENTION

Historically, a variety of image-input devices known as “optical scanners” have been used for capturing images and text, either written or printed, converting the captured information into a format readable by computers or other electronic devices. These devices capture written or printed information through a process known as “scanning”. A standard “scanning format” is the so-called Optical Character Recognition (“OCR”). Through this process, the information in a document is converted into a digital form.

Generally, these optical scanners have been of a large scale requiring a beam scanning mechanism, an original document feeder such as an image scanner or the like, resulting in virtually no portability of the device. Also, while scanning whole pages of text, it is difficult for these scanners to scan selected portions of a page. Instead, the entire page must be scanned. Thus, these devices also offer little, if any, selectivity.

With the development of notebook computers and personal display assistants (PDA), portability of devices has become more and more desirable. Also, with the advent of Windows based computer systems, “cutting and pasting” of selected portions of text from an electronic document has become a standard feature of almost every computer system. The applications programs permit the text entered from a document to be manipulated within the memory of the computer for rearrangement. Recently, hand-held optical scanners have been developed in an attempt to meet some of these needs. These hand-held scanners give the user the ability to scan documents into a machine readable format coupled with the ability to selectively cut and paste text. Using currently available hand-held scanners, one can selectively scan portions of a printed or written document into a machine-readable format so that the scanned information can be manipulated using any number of software applications.

While selectively scanning text is desirable, many people, especially students, use writing instruments to underline and/or highlight portions of text in books and articles. Students often selectively underline and/or highlight portions of text to aid in the learning process by facilitating the committing to memory of the selected information. Also, highlighting portions of text allows the reader to quickly discern more relevant parts of the text when reviewing the article or book after a first read. While the hand-held scanning devices allow for the capture of information, the ability to highlight and/or underline the text being scanned is also desirable because it leaves a permanent record in the text as to what the reader scanned and found to be important. Thus, making it particularly desirable to incorporate a scanning device with a marking device. Furthermore, it is highly desirable to provide a device that in a single, unitary apparatus includes both scanning and highlighting capabilities. Moreover, a device having these functions integrated in order to minimize in bulk and size aids in portability.

In view of the aforementioned shortcomings, there exists a strong need in the art for a hand-held scanning and marking device.

### SUMMARY OF THE INVENTION

There remains a need for a device that provides hand-held scanning capabilities while also allowing for highlighting of the text that is scanned. It is desirable to have a device that has both these capabilities in a single, integrated housing to minimize size and bulk.

In one embodiment, it is desirable to have the ability for the hand-held scanning device of the present invention to be able to communicate with a variety of electronic storage devices including computers, personal display assistants and cellular telephones. Moreover, it is desirable that the present invention be provided with different types of communication protocols so that wire, wireless and infrared can be conducted between an electronic storage device and the hand-held scanning and marking device. By having these differing communication capabilities, the present invention can easily transfer scanned information into a variety of different formats. Thus, only one hand-held scanner is needed instead of scanners for each of the different communication formats.

In yet another embodiment, one of skill in the art would appreciate that it is highly desirable to make a hand-held scanning and marking device in which the marking component is a replaceable marking cartridge such as a marking or similar material. Furthermore, it is desirable to have the electronic components of the present invention to reside on a circuit board placed inside a hollow, cylindrical replaceable marking cartridge. It would also be readily apparent to one skill in the art that it is desirable to provide the present invention with a cartridge shield to protect the components from being damaged by the ink contained in the replaceable marking cartridge.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is an environmental view of an embodiment of the present invention showing a self-contained hand-held scanning and marking device;

FIG. 2 is an exploded view of the embodiment of the invention illustrated in FIG. 1;

FIGS. 3 and 3a are perspective views of the components of the embodiment of the present invention illustrated in FIG. 1;

FIG. 4 is a side view of the embodiment of the invention illustrated in FIG. 3;

FIG. 5 is an exploded view of the battery/light source/switch housing of the embodiment of the present invention illustrated in FIG. 4;

FIG. 6 is side view of another embodiment of the present invention;

FIG. 7 is an exploded view of the embodiment illustrated in FIG. 6; and

FIG. 8 is a side view of yet another embodiment of the present invention.

### DETAILED DESCRIPTION

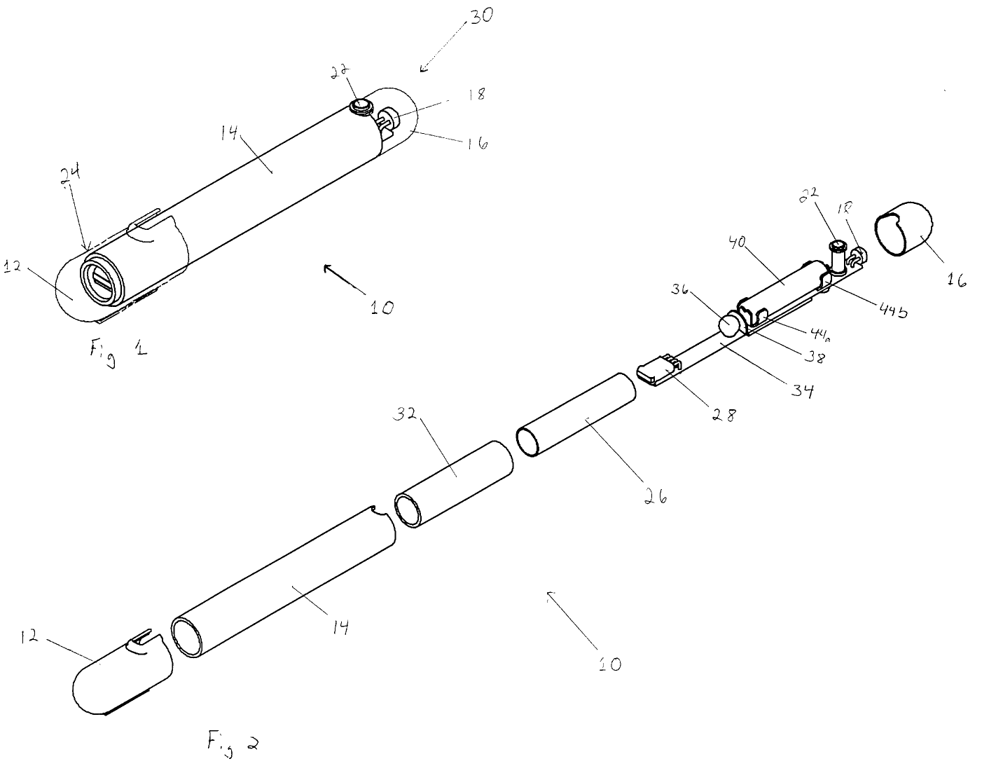

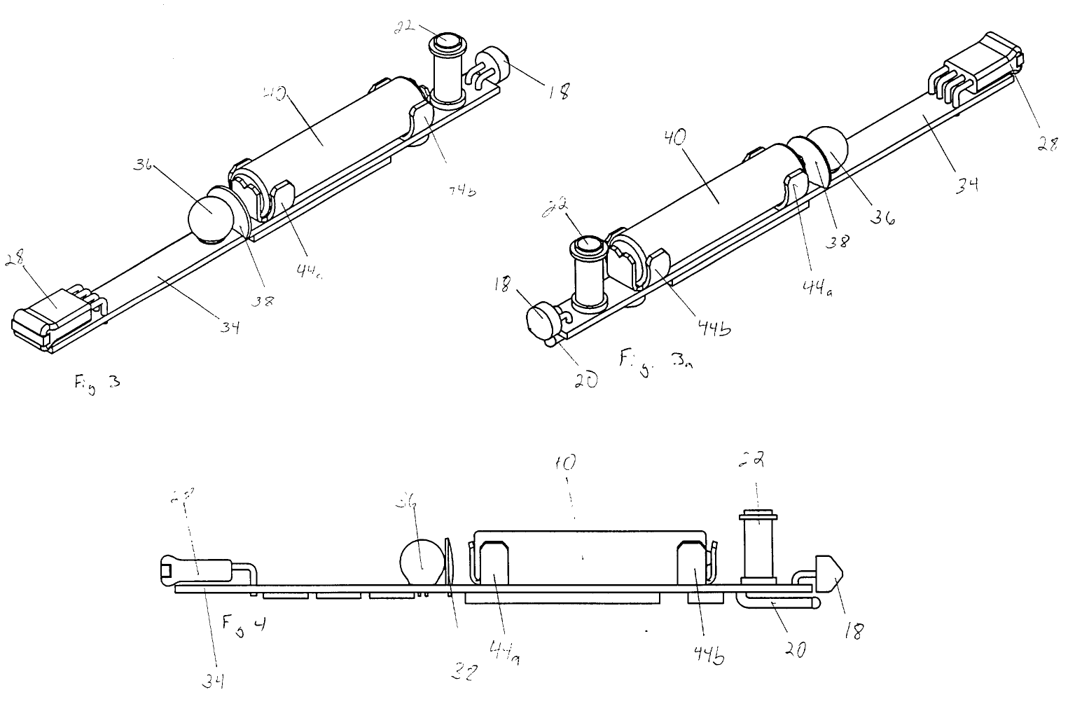

The present invention will now be described with reference to the drawings, wherein like reference numerals are used to refer to like elements throughout. FIG. 1 illustrates an environmental view of an embodiment of the present invention including a hand-held scanning apparatus with marking capabilities seen generally at 10. The device 10 allows for the optical capture of written or printed text or images while providing highlighting and/or marking capabilities. As best seen in FIGS. 1 and 2, the hand-held scanning and marking device 10 generally includes a cap 12, housing 14 and end cap 16 along with an infrared transmitter 18, wireless transmitter 20 and a wire port 22.

The cap 12 protects the scanning tip, seen generally at 24, from damage when the hand-held scanning device 10 is not in use. The scanning tip 24 includes a marking tip of a highlighter cartridge 26 and a reading end of a reader 28. The cap 12 can frictionally engage the housing 14 in order to hold the cap in place. One of skill in the art will recognize that the marking device is not necessarily limited to a highlighter, but can be any type of writing instrument such as an ink pen, pencil or permanent marker.

At the opposing end of the device 10, a transmission end 30 can be generally seen. The transmission end 30 has the end cap 16 affixed to it. The end cap 16 can provide protection for both an infrared transmitter 18 and a wireless transmitter 20 that can be respectively positioned at the transmission end 30. As can be best seen in FIG. 1, a standard port for wire connection 22 to a computer or PDA is also illustrated at the transmission end 30 with this port 22 protruding from the end cap 16. This wire connection port 22 can be any type of standard device to device wire connector such as a USB connection. Of course, one of skill in the art will readily appreciate that the invention can utilize any combination of these different types of transmitter or simply have a single type of transmitter.

Turning to FIG. 2, an exploded perspective view of an embodiment of the present invention is illustrated. As best shown in FIG. 2, the device 10 includes a hollow, highlighting cartridge 26 for marking or highlighting documents. In one embodiment, the highlighting cartridge 26 is a marking cartridge that is replaceable. The marking carries ink that can be transmitted to a document when the tip of the cartridge contacts with the document. By sliding the hand-held scanning and marking device 10 across a document, ink from the marking cartridge 26 is imparted to the document. This results in the selected text being highlighted.

When all the ink of the cartridge 26 is used, the user may remove the cartridge 26 from the housing 14 and replace it with a fresh cartridge. The hollow, highlighting cartridge 26 may be wrapped in a plastic film or paper on its respective interior and exterior surfaces. This aids in keeping the ink from leaking out of the cartridge when being placed into the housing 14 and prevents ink from smearing or smudging onto the users hands during the replacement process.

As can also be seen in FIG. 2, the device 10 includes an ink shield/light tube 32 that resides inside the highlighting cartridge 26. The ink shield/light tube 32 can serve several functions. First, it protects the various internal components of the present invention from contacting the interior surface of the highlighting cartridge 26. By having this in place, the internal components including the reader 28 cannot be damaged or marked with the highlighting when the user is replacing a used highlighting cartridge 26. It also helps minimize the tip of the highlighting cartridge 26 from contacting the reader 28 during use. This allows the reader to be placed very close to the surface that is being scanned resulting in quicker and more accurate scanning of information. Also, reader's proximity to the scanned material eliminates the need for magnification of the scanned information as it is scanned into the device. Additionally, the ink shield/light tube 32 minimizes light scatter and helps focus the light used in the scanning process.

The ink shield/light tube 32 may be fabricated from any suitable material such as a plastic and is held in place by any conventional means including frictionally engaging an interior surface of the highlighting cartridge 26. To help minimize, if not eliminate light scatter all together, the ink shield/light tube 32 can be an opaque material. The opaqueness of the tube 32 helps concentrate and focus scanning light when a scanning operation is being performed. Also, one of skill will readily appreciate that instead of utilizing an opaque tube, the tube 32 may be at least partially coated with a reflective coating so that light is reflected in a predetermined path from the light source to the scanning end. In one embodiment, a transparent light tube can be partially coated with a reflective coating to achieve this desired result.

The light tube 32 focuses the light so that the reader may operate at peak efficiency. Among the components that the ink shield/light tube 32 protects is the reader 28 located at the scanning end of the present invention. As seen in FIGS. 1 and 2, the reader 28 is fixed at one end to an integrated circuit board 34 with the other end residing within the ink shield/light tube 32 at the end of the highlighting cartridge 26 that contacts the document. In one embodiment the reader 28 acts a pressure sensitive switch so that besides scanning in text, when sufficient pressure is exerted on the device 10, more namely the reader 28, the device switches on and the reader 28 begins scanning text from a document. This pressure-sensitive switch is used to conserve battery power by only allowing the device 10 to be operated when in contact with a document being scanned. This keeps the device 10 from inadvertently try to scan when the device is not in a position to capture text. The device may also have a manually operated on/off switch that activates or deactivates the battery when engaged.

In one embodiment, the pressure sensitive switch has a time lag where upon removal of pressure, the device 10 does not automatically shut off, but instead remains on for a set time period, such as ten seconds. Once the set time period expires, the device 10 then turns off. When pressure is re-applied, the device 10 then turns back on. This allows the device 10 to stay on while avoid battery drain that can be associated with constant turning on and off of the device 10. Also, in one embodiment, the user can even set the lag time to his liking.

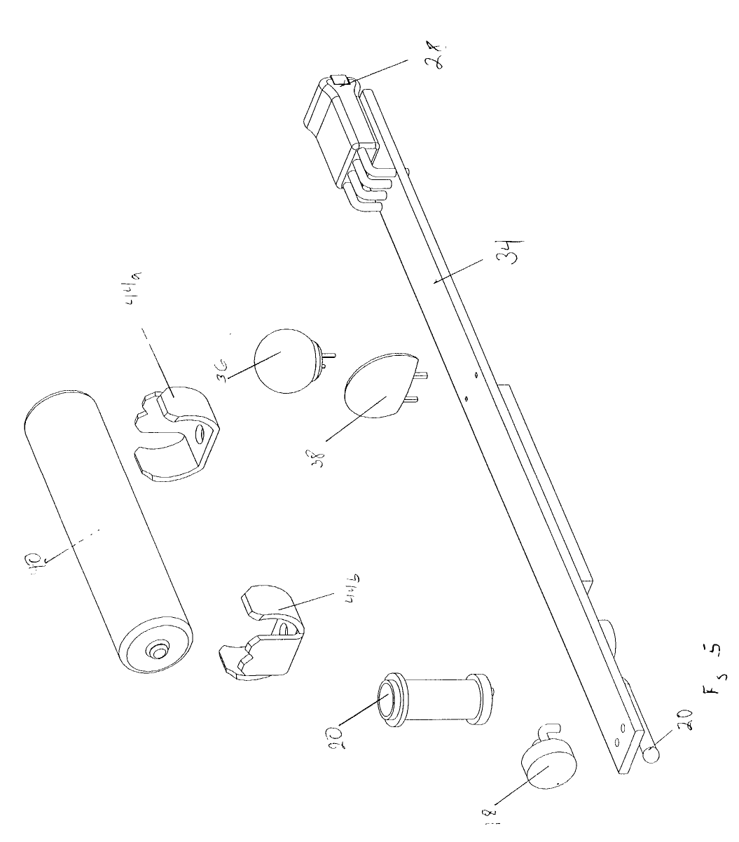

Besides the pressure sensitive switch, the reader 28 has a photo-electric conversion element which is in communication with a central processing unit (CPU). The reader can communicate to the CPU in any number of conventional methods including the option of hardwiring the components. The CPU in turn is preferably wired to the other components via the large scale integrated (LSI) circuit board 34. The LSI circuit board 34 can be flexible, curved or any other geometrical configuration capable of being insert and held in place within said ink shield/light tube 32. FIGS. 3 and 4 further illustrate the reader 28 and its interconnection to the integrated circuit board 34 and components thereon.

The CPU communicates with a system memory as well as the output transmission device(s). While one of skill in the art will readily appreciate that any variety of wiring schemes can be utilized with the present invention, it is preferred to use the LSI circuit board 34. The CPU connects to the system memory as well as all output transmission devices via the circuit board. When information is scanned into the device, it is stored in the memory until transmission to the electronic storage machine occurs. One of skill in the art will appreciate that if a direct wire connection is utilized, the device 10 may be designed where information is transmitted from the reader to the computer or PDA without passing through the invention's memory. Also, it is contemplated that the device can be made without an internal memory and instead rely on an external memory such as memory located in a computer or a PDA.

Connected to the reader 28 via circuit board 34 and enclosed within the ink shield/light tube 32, is the light source 36 and reflector 38. As can be best seen in FIGS. 2, 3 and 4, the light source 36 resides on the LSI circuit board 34 with the reflector 38 positioned behind it, but in front of other components such as a power source 40 and output transmission devices. The light source 36 any type of LED or other low-heat light source. LEDs have a long life and minimize heat generation that can be beneficial to applications such as the present. Furthermore, it is contemplated that the reader 28 may be placed behind the light source 36 but in a proximity to the reader to minimize light scatter. In this arrangement, it is contemplated that the light source 36 would be of the LED type.

Like the light tube 32, the reflector 38 acts to concentrate the light onto the reader 28 and minimize scatter. In a preferred embodiment, the reflector 38 is permanently affixed to the circuit board 34 and its outer edge preferably engages the inner surface of the ink shield/light tube 32 in order to effectively form a chamber 42 between the interior surface of the ink shield/light tube 32 and the reflector 38. This chamber 42 holds the majority, if not most, of the light emitting from the light source 36 within the chamber 42. By retaining the light within this chamber 42, the reader 28 has the light necessary for it to operate properly without light escaping out the transmission end 30 of the device 10.

As can be seen in FIGS. 3 and 4, a power source 40 is included within the hand-held scanning device 10 for powering the operation of the device 10. As illustrated, the power source 40 is held in place by two clips 44a, 44b that in turn distribute power to the device 10 through conventional battery means. The power source 40 can be virtually any type of known long-life battery such as nickel cadium or lithium. The power source 40 can also be a standard dry-cell AAA battery. Also, if desired, an external power source can be utilized. It is contemplated that such an external power source would attach to the device in any variety of standard power connections. It is further contemplated that the power source can be a “bendable” battery, i.e., a battery designed for flexing or bending.

At the transmission end 30 of the device 10 can be found a number of output devices capable of transmitting scanned information to a machine such as a desktop or notebook computer or PDA. As can be seen FIGS. 2, 3 and 4, in a preferred embodiment, the device can have an infrared transmitter 18, a wireless transmitter 20 as well as a standard wire connection transmitter 22. The infrared transmitter 18 can be covered by the end cap 16, which is transparent. The infrared transmitter 18 can communicate with infrared receiver of a storage device. Information scanned into the device 10 via the reader 28 can ultimately be transmitted to the desired storage machine through whichever output device is capable of communicating with the storage machine.

In operation, the scanned information that is stored in memory is routed from memory to the transmitter and into the storage machine. The standard wire connection transmitter 22 can be any known connection utilizing a port on a computer. This includes serial ports and USB ports. The infrared transmitter 18 can be a transmitter as in known in the art that sends information via an infrared beam. Finally, a wireless transmitter 20 is included so that the device is capable of sending the scanned information to the storage device without wires. The wireless transmitter 20 can operate using any of the well known wireless communication protocols such as Bluetooth.

When in operation, the tip of the reader 28 is engaged with the document to be scanned. By pressing the tip of the reader 28 onto the document, the pressure-sensitive switch is tripped, the light source 36 powers up, the internal components are activated and the scanning operation begins. In order to ensure that the sufficient pressure was exerted to trip the switch an indicating means such as a light or buzzer may be set off as the scanning operation begins.

Once the device 10 is on, the user moves the device 10 across the text desired to be scanned. Utilizing the light from the light source 36, the reader 28 engages in an optical scanning operation thereby capturing the text which the CPU routes into memory. At the same time, the highlighter cartridge 26 is marking the text on the original document with ink. Thus, the text is captured in an electronic format while at the same being permanently marked.

Once the text is scanned, the user may connect the device 10, using whichever transmitter is compatible, to an electronic storage machine so that the text may be transmitted to the machine. Upon successful transmission, the user may manipulate the text with an applications program contained on the storage machine. Thus, the user has a permanent record of the information scanned as well as an electronic version of the scanned text.

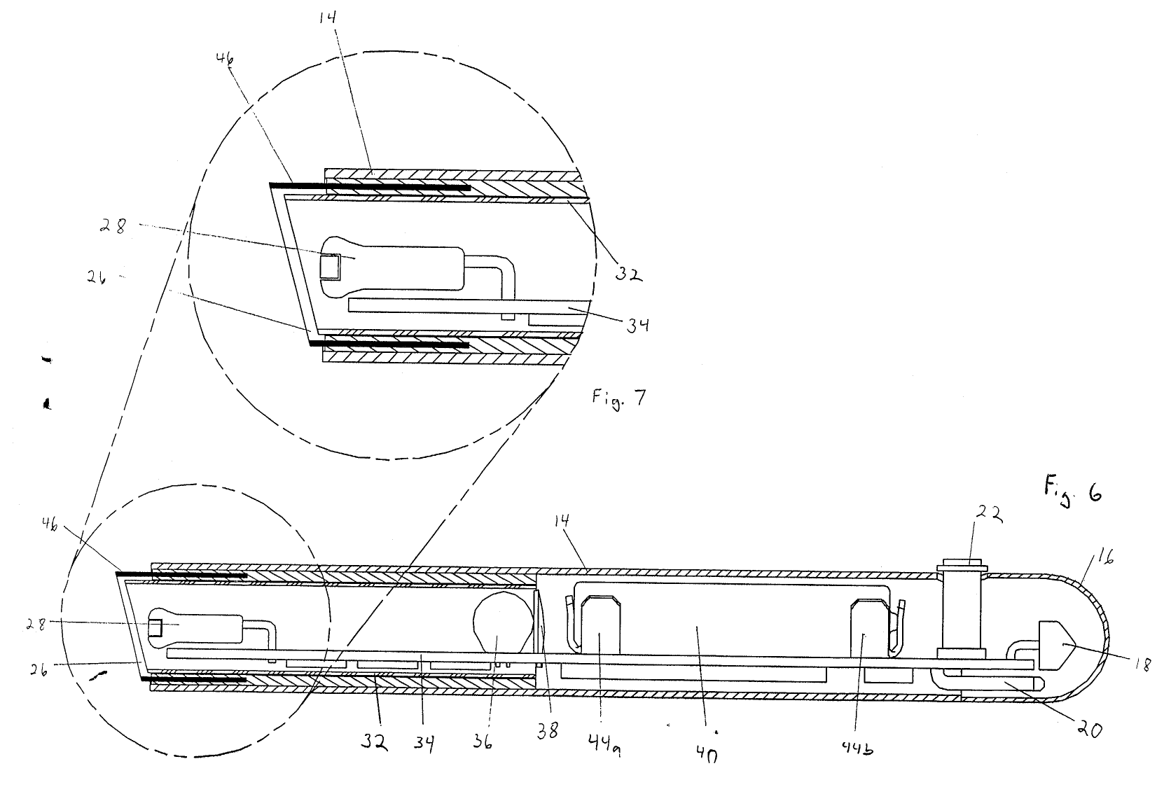

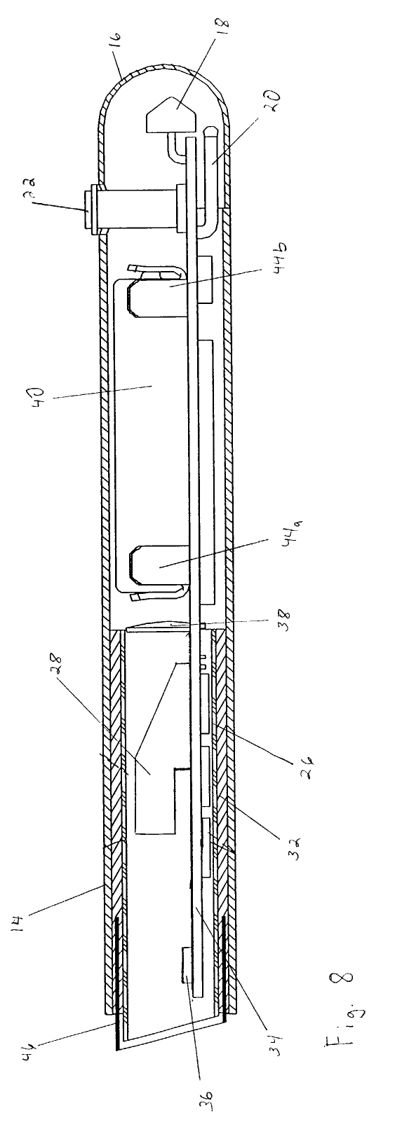

FIGS. 6 and 7 illustrate yet another embodiment of the present invention. In this embodiment a wick or tip 46 is inserted into the highlighting cartridge 26 for easy dispersal of the ink onto the surface being highlighted. The tip 46 can be fabricated of a material that readily pulls or wicks ink from the highlighter cartridge 26 to the surface being highlighted. This tip 46 makes the dispersal of ink more uniform, reduces mess and also further aids in protecting the reader 28 in that stray marking material from the highlighting cartridge 26 is less likely to deposit on the reader 28.

FIG. 8 illustrates yet another embodiment of the present invention where at least one LED 36 is affixed to the circuit board in front of the reader 28 while having the wick or tip configuration discussed above. The LED 36 being place in front of the reader 28 helps minimize light scatter. In this embodiment, the reader 28 houses an optical character reader (OCR) as well as a lens and a mirror or other reflective surface. In operation, light emits from the LED 36 as the device is drawn across text to be scanned. The light from the LED 36 is focused by the lens of the reader 28 and then reflected by the mirror onto to the OCR. The OCR converts the light energy into a signal that is forwarded to the processor for processing into scanned text.

Finally, one of skill in the art will recognize that additional features such as an LCD screen can be incorporated any embodiment of the present invention. It is contemplated that an LCD screen can be placed near the transmission end of the device to provide the user with information including exactly what text is being scanned into the apparatus.

One of skill in the art will readily appreciate that simultaneous scanning and transmission of the scanned information is possible. Also, one of skill in the art will understand that an ink pen or other writing instrument can be incorporated into the present invention in place of the highlighter or in conjunction with it.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An apparatus for hand-held scanning and marking operations comprising:
a) a highlighter cartridge for highlighting text or graphics;
b) a reader adapted for scanning said text or graphics and contained at least partially within said highlighter cartridge;
c) an ink shield in contact with said highlighter cartridge and protecting said reader from said highlighter cartridge;
d) at least one output transmitter in communication with said reader and capable of transmitting said scanned text or graphics to an electronic storage device and
e) a housing at least partially containing said highlighter cartridge.

2. The apparatus of claim 1 further comprising:
a) an integrated circuit board at least partially contained within said highlighting cartridge and in communication with said reader and said at least one output transmitter and
b) a central processing unit (CPU) located on said integrated circuit board for controlling the operation of said apparatus.

3. The apparatus of claim 3 further comprising:
a) a memory in communication with said central processing unit and located on said integrated circuit board.

4. The apparatus of claim 4 further comprising:
a) an internal light source in communication with said integrated circuit board and capable of emitting light into said ink shield.

5. The apparatus of claim 1 wherein said at least one output transmitter is a wireless transmitter.

6. The apparatus of claim 1 wherein said at least one output transmitter is an infrared transmitter.

7. The apparatus of claim 1 wherein said at least one output transmitter is a wire connection.

8. The apparatus of claim 1 further comprising:
a) an internal power source and
b) a pressure sensitive switch for activating said internal power source.

9. An apparatus for hand-held scanning and marking operations comprising:
a) a hollow highlighter cartridge for highlighting text or graphics;
b) an integrated circuit board having a central processing unit and a memory at least partially within said hollow highlighter cartridge;
c) an optical reader in communication with said central processing unit and adapted for scanning said text or graphics and contained at least partially within said highlighter cartridge said reader having a pressure sensitive switch for activating the apparatus;
d) an ink shield in contact with said highlighter cartridge and protecting said reader from said highlighter cartridge;
e) a light source at least partially contained within said ink shield for providing illumination for said reader;
f) an internal power source capable of being turned on by said switch and powering said light source;
g) at least one output transmitter in communication with said reader and capable of transmitting said scanned text or graphics to an electronic storage device and
h) a housing at least partially containing said highlighter cartridge.

10. The apparatus of claim 9 wherein said at least one output transmitter is a wireless transmitter.

11. The apparatus of claim 9 wherein said at least one output transmitter is an infrared transmitter.

12. The apparatus of claim 9 wherein said at least one output transmitter is a wire connection.
